(19) United States
(12) Patent Application Publication
(10) Pub. No.: US 2003/0091965 A1
(43) Pub. Date: May 15, 2003

(54) Step-by-step english teaching method and its computer accessible recording medium

(76) Inventors: Kuang-Shin Lin, Taipei (TW); Wei Jiang, Tianjin (CN)

Correspondence Address: BIRCH STEWART KOLASCH & BIRCH, PO BOX 747, FALLS CHURCH, VA, 22040-0747, US

(21) Appl. No.: 10/282,105

(22) Filed: Oct. 29, 2002

(30) Foreign Application Priority Data
Nov. 9, 2001 (TW) 90127846

(51) Int. Cl. G09B 19/00

(52) U.S. Cl. 434/156

(57) ABSTRACT

A systematic English teaching method and its computer accessible recording medium are disclosed. Through a learning module designed for a computer accessible recording medium, the method is implemented in a computer controllable device. The method includes the steps of: storing data relevant for learning English into a computer accessible recording medium, establishing a set of complete and meaningful level classification index, a user taking an evaluation by doing test problems provided by a learning module, producing a corresponding level classification index according to the evaluation result, organizing learning data in the learning module according to the level classification index, and the user using the learning data to learn English step by step.

### BACKGROUND OF THE INVENTION

1. Field of Invention

The invention relates to a computer-aided English teaching method and, in particular, to a systematic English teaching method and the corresponding computer accessible recording medium.

2. Related Art

The conventional English learning method in many Asian countries usually starts from learning elements in a sentence and then making a whole sentence. A common result is that learners can only read texts but do not know how to write, or can listen to other people speaking English but dare not say a word. Obviously, such a teaching or learning method cannot achieve the ultimate goal of mastering a foreign language. Merely reading but not writing and listening without speaking make the language learning a task with the lowest reward even after spending a lot of time.

Learning English covers phonetic symbols, pronunciation, vocabulary, idioms and phrases, syntax, sentence structures and reading. However, it is still very hard to find a teaching material that integrates the above-mentioned contents into a systematic and well-organized database and presents the subject in a comprehensive and convenient way. How to relate existing English learning data, how to utilize the superior computer technology to form a network among the data, and how to classify and organize all available data to satisfy individual learner's needs constitute a immense and complicated project.

To meet the needs of English learning, an exchange website or a computer accessible recording medium that builds a complete information service database from the huge amount of English learning data is an important subject worth some efforts.

### SUMMARY OF THE INVENTION

A primary objective of the disclosed language learning method is to allow users to be able to read, write, listen and speak sentences by using a learning module designed for a computer accessible recording medium and implemented in a computer controllable device.

The learning method of the invention can be implemented in a one-touch OS on a computer controllable hardware platform or a normal computer controllable platform. Moreover, on-line learning mode can be performed through the Internet linkage. In accordance with one's needs, the learner can perform some evaluation to find out his or her level. All learning data collected are organized according to a level classification index. Functional learning materials of phonetic symbols, pronunciation, vocabulary, idioms and phrases, syntax, sentence structures and reading are given to the learner in a selective way according to the practical needs of the learner. Therefore, the invention can indeed achieve the goal of systematic learning.

### BRIEF DESCRIPTION OF THE DRAWINGS

The invention will become more fully understood from the detailed description given hereinbelow illustration only, and thus are not limitative of the present invention, and wherein:

FIG. 1 shows the disclosed systematic English teaching method and a hardware structural diagram of its computer accessible recording medium;

FIG. 2 is a flowchart of teaching processes in the invention;

FIG. 3 is a flowchart of switching among different learning materials in the invention;

FIG. 4 is a schematic view of the whole data structure of the invention;

FIG. 5 is a schematic view of the structure of phonetic symbol learning data;

FIG. 6 is a schematic view of the structure of pronunciation learning data;

FIG. 7 is a schematic view of the structure of pronunciation rule learning data;

FIG. 8 is a schematic view of the structure of stress learning data;

FIG. 9 is a schematic view of the structure of sentence reading skill learning data;

FIG. 10 is a schematic view of the structure of vocabulary learning data;

FIG. 11 is a schematic view of the structure of idioms and phrases learning data;

FIG. 12 is a schematic view of the structure of syntax learning data;

FIG. 13 is a schematic view of the structure of sentence structure learning data; and

FIG. 14 is a schematic view of the structure of reading learning data.

### DETAILED DESCRIPTION OF THE INVENTION

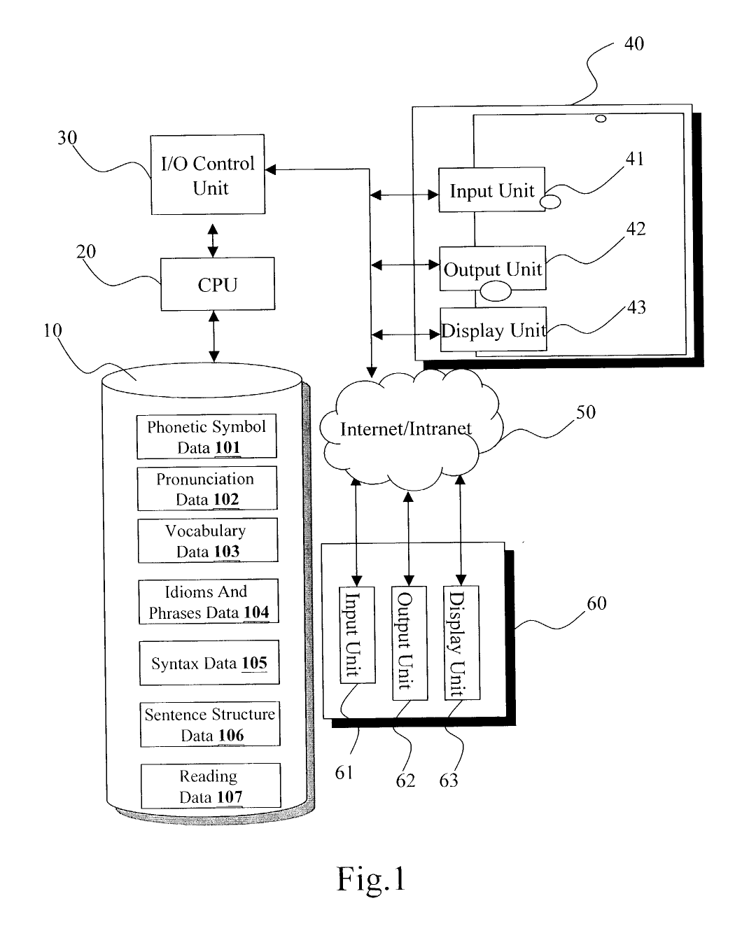

The hardware structure of the disclosed computer accessible recording medium of the invention is shown in FIG. 1. All English teaching related data are stored in a database 10 of the computer accessible recording medium. The database 10 contains phonetic symbol data 101, pronunciation data 102, vocabulary data 103, idioms and phrases data 104, syntax data 105, sentence structure data 106, and reading data 107. Through a CPU (main control unit) 20 and an operating program (not shown) or from the above data structure, a user can obtain data in the related fields 101˜107 to learn English.

Data in a user interested fields 101˜107 utilizes an I/O (Input/Output) control unit 30 as an I/O conversion interface. Data in the interested field 101˜107 are entered through an input unit 41 of a single machine 40; and the data are output from an output unit 42. The data of the interested field 101˜107 are presented on a display unit 43. The recording medium of the invention can further provide services to a plurality of client machines 60 through the Internet/Intranet 50. Through an input unit 61 of a client machine 60, the user enters an interested field 101˜107. The data in the interested field 101˜107 are output from an output unit 62 and displayed on a display unit 63.

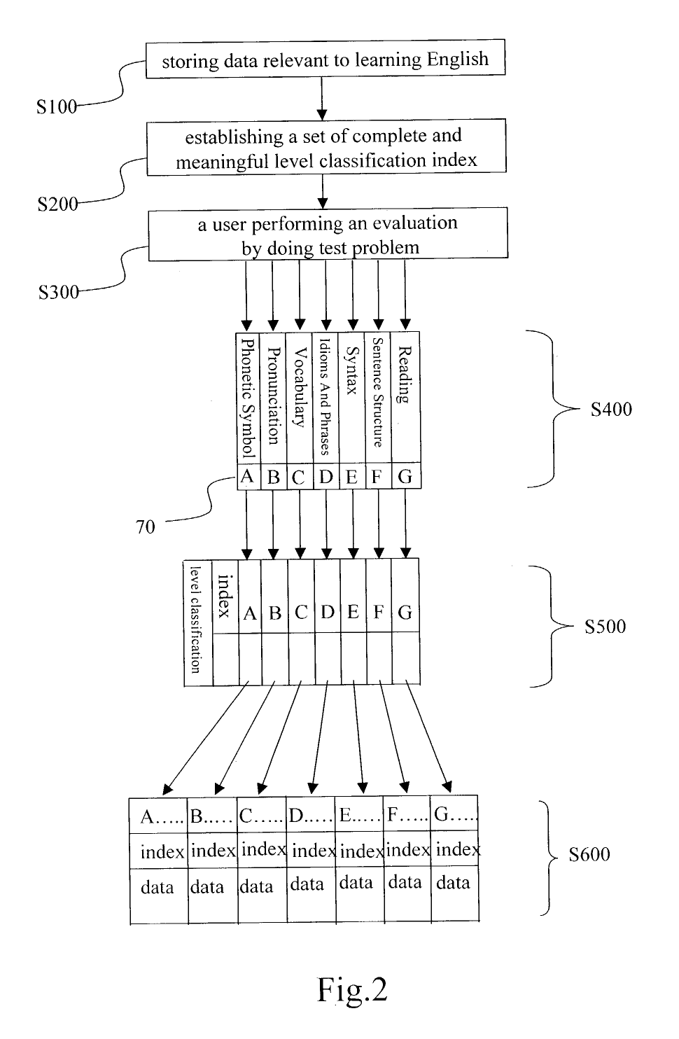

With reference to FIG. 2, a main objective of the invention is to associate and integrate data in each level (including phonetic symbols, pronunciation, vocabulary, idioms and phrases, syntax, sentence structures and reading). An intelligence integration technique is employed to systematically relate English learning data. Therefore, to organize these complicated but related learning materials, in step 100 of preparing English related data a set of complete and meaningful level classification index 70 has to be established (step 200). In step 300, the user passes an evaluation. Following the level classification index 70, all data thus prepared are organized (step 400) and appropriate level learning index relations are established (step 500). In step 600, the system generates class data for the corresponding learning level so that the learner can learn an interested field 101˜107 according to his or her English ability level. This is how the invention achieves the goal of systematic English learning.

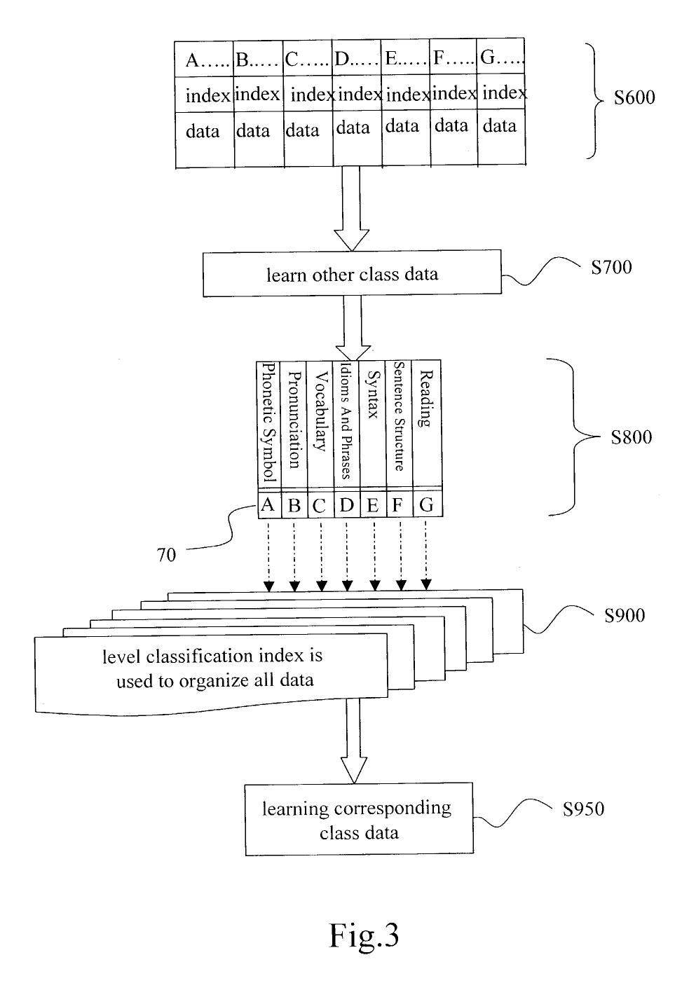

As shown in FIG. 3, after the system generates the class data for the corresponding learning level (step 600), if the learner still wants to learn other class data (step 700) then the above-mentioned level classification index 70 is used to organize all data (step 800), thereby organizing the data (step 900) and learning corresponding class data (step 950).

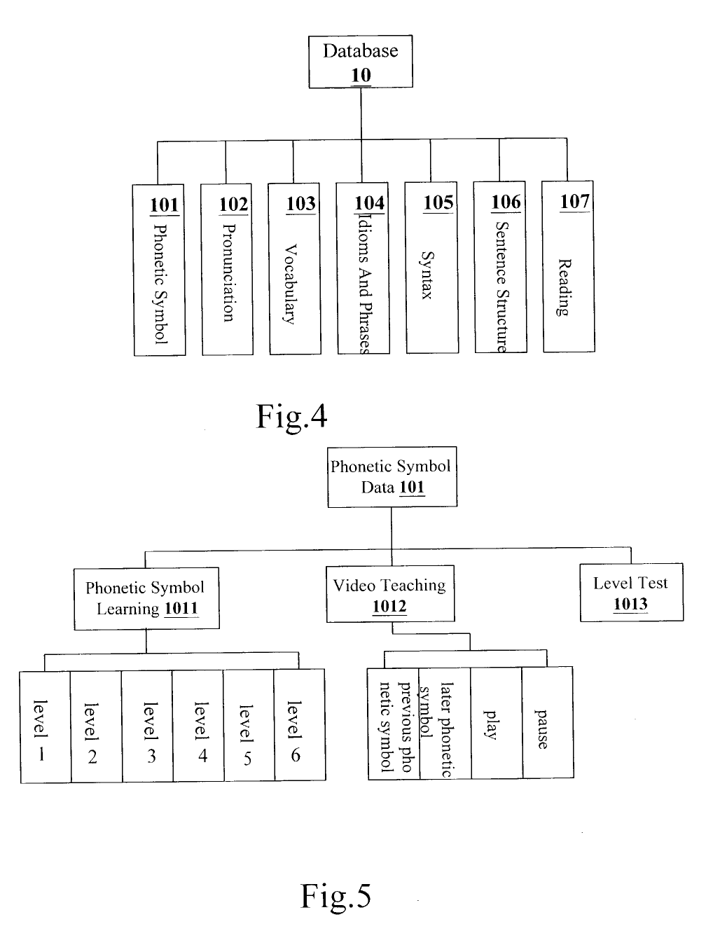

The disclosed systematic English teaching method is implemented in a database 10 of a computer accessible recording medium. With reference to FIG. 4, the data structure of phonetic symbol data 101, pronunciation data 102, vocabulary data 103, idioms and phrases data 104, syntax data 105, sentence structure data 106, and reading data 107 in the database 10 are applied to a one-touch OS (Operating System) on a computer controllable hardware platform.

As illustrated in FIG. 5, the phonetic symbol data 101 include phonetic symbol learning 1011, video teaching 1012, and level test 1013. The phonetic symbol learning 1011 provides learning contents for different levels. The video teaching 1012 provides the operations of a previous phonetic symbol, a later phonetic symbol, play and pause. The level test 1013 performs an evaluation according to the level classification index 70. The evaluation result is then used to produce a new level classification index 70 for determining the learner's new learning level.

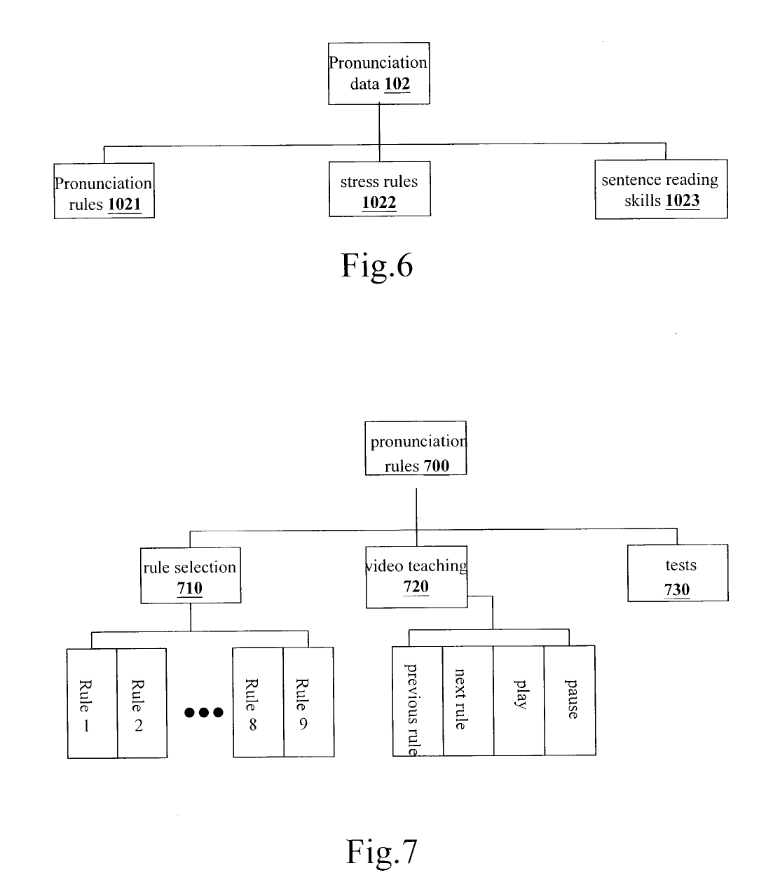

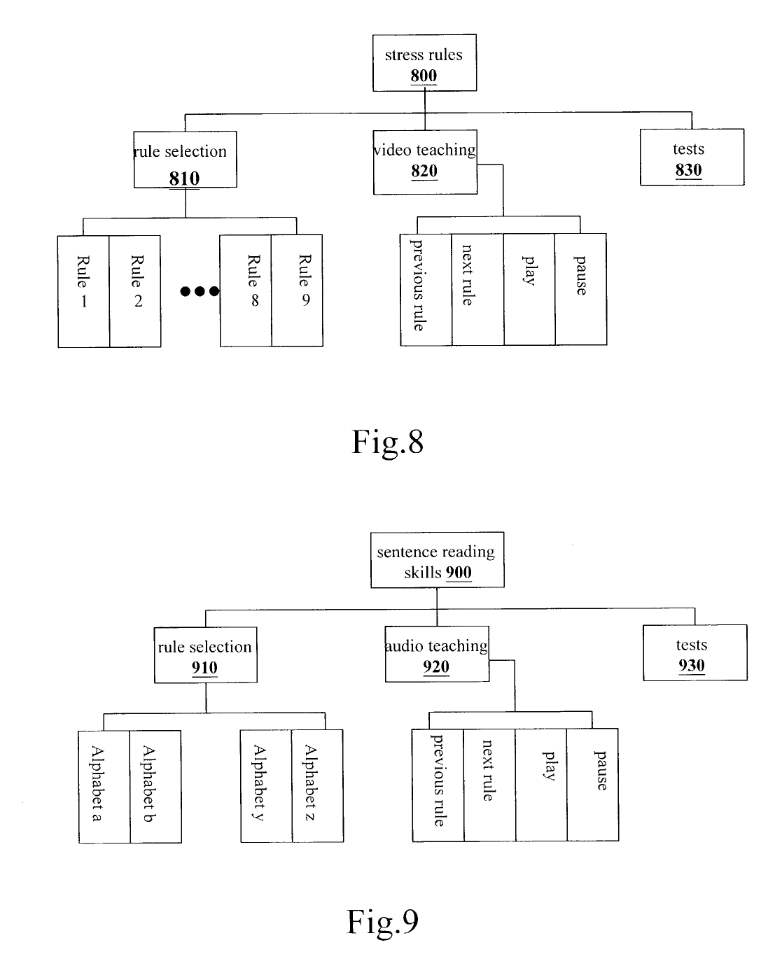

With reference to FIG. 6, the pronunciation data 102 include pronunciation rules 1021, stress rules 1022, and sentence reading skills 1023. As shown in FIG. 7, the pronunciation rules 700 include rule selection 710, video teaching 720, and tests 730. The rule selection 710 includes a plurality of rules for selection. The video teaching provides operations of a previous rule, a next rule, play and pause. The tests 730 provide related evaluation. With reference to FIG. 8, the stress rules 800 include rule selection 810, video teaching 820, and tests 830. The rule selection 810 includes a plurality of rules for selection. The video teaching 820 provides operations of a previous rule, a next rule, play and pause. The tests 830 provide related evaluation.

With reference to FIG. 9, the sentence reading skills 900 include rule selection 910, audio teaching 920, and tests 930. The rule selection 910 includes alphabets a through z for selection. The audio teaching 920 provides operations of a previous rule, a next rule, play and pause. The tests 930 provide related evaluation.

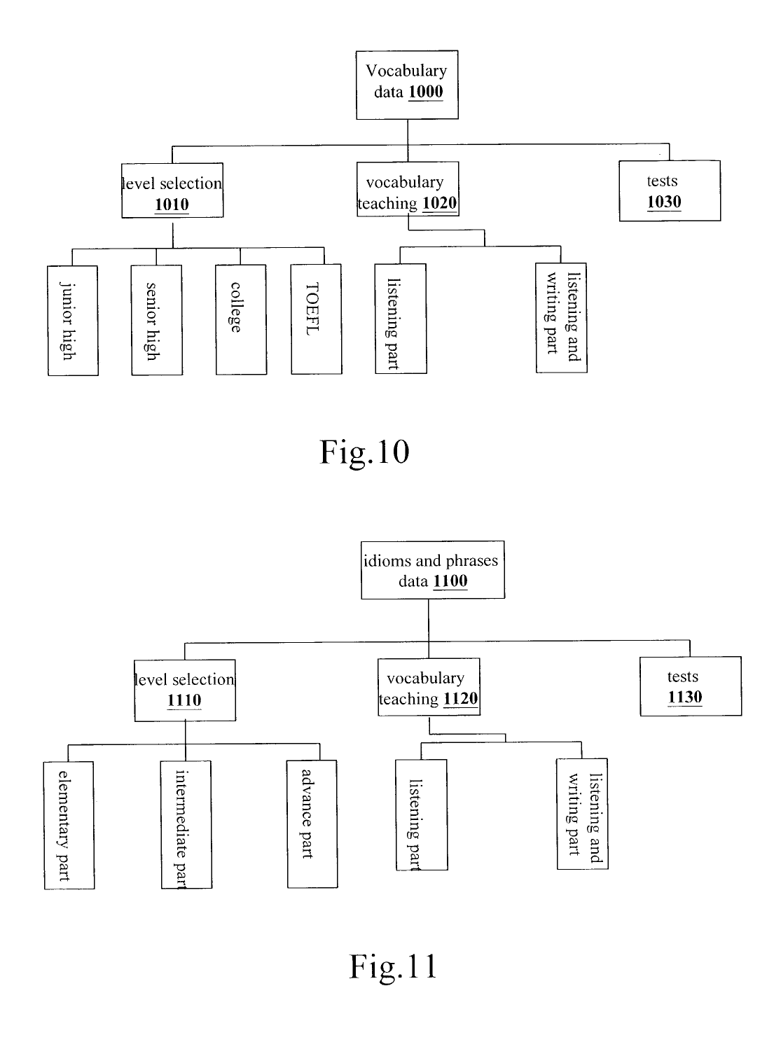

As shown in FIG. 10, the vocabulary learning structure provides vocabulary data 1000, including level selection 1010, vocabulary teaching 1020 and tests 1030. The level selection 1010 has levels ranging from junior high, senior high to college and TOEFL. The vocabulary teaching 1020 has a listening part and a listening and writing part. The tests 1030 provide related evaluation.

The idioms and phrases learning structure in FIG. 11 provides idioms and phrases data 1100 that include level selection 1110, vocabulary teaching 1120 and tests 1130. The level selection 1110 has an elementary part, an intermediate part, and an advance part. The vocabulary teaching 1120 has a listening part and a listening and writing part. The tests 1130 provide related evaluation.

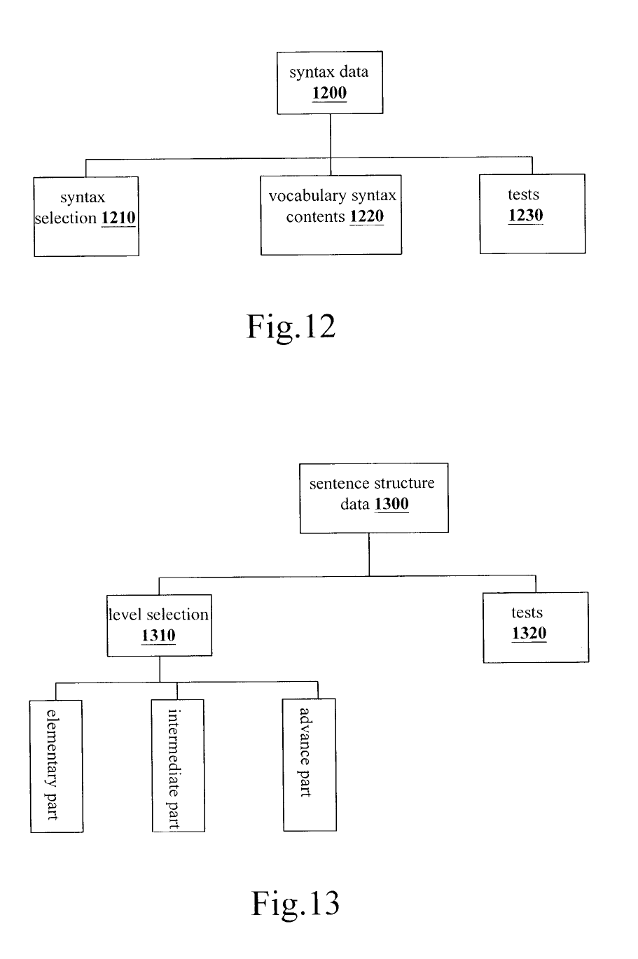

The syntax learning structure in FIG. 12 provides syntax data 1200 that include syntax selection 1210, vocabulary syntax contents 1220 and tests 1230.

The sentence structure learning in FIG. 13 provides sentence structure data 1300 that include level selection 1310 and tests 1320. The level selection 1310 has an elementary part, an intermediate part, and an advance part.

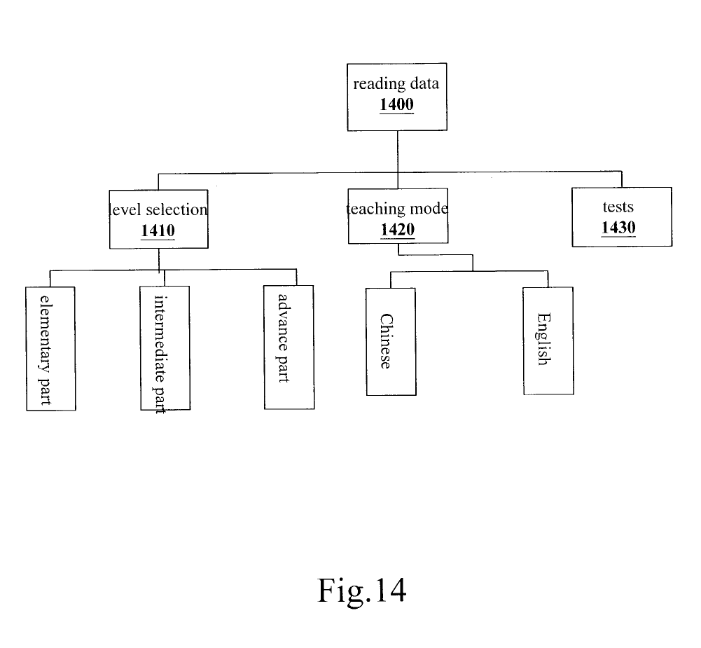

The reading learning structure in FIG. 14 provides reading data 1400 that include level selection 1410, a teaching mode 1420 and tests 1430. The level selection 1310 has an elementary part, an intermediate part, and an advance part. The teaching mode 1420 supports Chinese and English.

The systematic English teaching method disclosed herein is a very efficient English learning method. The invention breaks traditional concepts in learning English and proposes the English Express Learning Theory—one learns sentences first then sentence elements, which is very close to the natural learning method for a native language.

The theory of “eight-type sentence making method” (phrase sentence making, advanced phrase sentence making, vocabulary sentence making, advanced vocabulary sentence making, prototype sentence making, advanced prototype sentence making, limit sentence making, and advanced limit sentence making) is used for users to learn a language step by step.

What is claimed is:

1. A step-by-step method of teaching English implemented in a computer controllable device through a learning module designed for a computer accessible recording medium, which method comprises the steps of:
storing data relevant to learning English in the computer accessible recording medium;
establishing a set of complete and meaningful level classification index;
a user performing an evaluation by doing test problem provided by the learning module;
generating a corresponding level classification index according to the evaluation result;
organizing the learning data in the learning module using the index classification index; and
the user learning English systematically using the learning data.

2. The method of claim 1, wherein the learning data include phonetic symbol data, pronunciation data, vocabulary data, idioms and phrases data, syntax data, sentence structure data, and reading data.

3. The method of claim 1 implemented in a one-touch OS (Operating System) on a computer controllable hardware platform.

4. The method of claim 1 supporting an online learning mode through a network.

5. The method of claim 1, wherein the user can selectively choose to learn any learning data.

6. A computer accessible recording medium for a step-by-step English teaching method comprising:
a database, which stores data for learning English, including phonetic symbol data, pronunciation data, vocabulary data, idioms and phrases data, syntax data, sentence structure data, and reading data; and
a learning module, which establishes a complete and meaningful level classification index and generates test problems for a user to perform an evaluation;
wherein a corresponding level classification index is generated according to the evaluation result and the learning data in the database are organized according to the generated level classification index so that the user can learn English step by step using the learning data.

7. The recording medium of claim 6 implemented in a one-touch OS (Operating System) on a computer controllable hardware platform.

8. The recording medium of claim 6 supporting an online learning mode through a network.

9. The recording medium of claim 6, wherein the user can selectively choose to learn any learning data.
